(19) United States
(12) Patent Application Publication
(10) Pub. No.: US 2026/0302571 A1
(43) Pub. Date: Oct. 1, 2026

(54) METHOD OF PROCESSING BATTERY AND METHOD OF PRODUCING BATTERY

(71) Applicant: HONDA MOTOR CO., LTD., Tokyo (JP)

(72) Inventors: Ikki KATADA, Saitama (JP); Shuichi KAZUNO, Saitama (JP); Hanzhi YANG, Saitama (JP); Jiahao LIU, Saitama (JP); Tomohiro INOUE, Saitama (JP)

(21) Appl. No.: 19/572,889

(22) Filed: Mar. 20, 2026

(30) Foreign Application Priority Data
Mar. 26, 2025 (JP) 2025-052233

(51) Int. Cl. H01M 50/609; H01M 4/04

(52) U.S. Cl. CPC H01M 50/609; H01M 4/0416

(57) ABSTRACT

A method of processing a battery is provided. The method performs processing by feeding fluid into an inside of the battery. The method includes a first step of providing a battery including one or more fluid inlets and one or more fluid outlets in an outer casing that houses an electrode, and a second step of cleaning the inside of the battery by injecting fluid through the fluid inlets and discharging the fluid from the fluid outlets.

### CROSS REFERENCE TO THE RELATED APPLICATION

This application is based on and claims the benefit of priority from Japanese Patent Application No. 2025-052233, filed on 26 Mar. 2025, the content of which is incorporated herein by reference.

### BACKGROUND OF THE INVENTION

### Field of the Invention

The present invention relates to a method of processing a battery and a method of producing a battery.

### Related Art

In recent years, a variety of studies have been made for making effective use of resources in batteries, such as lithium-ion batteries. A mainstream approach is to separate and recycle valuable metals such as cobalt and nickel from mixture of active materials and the like removed from waste batteries; however, it needs to go through complicated processes such as heat treatment and acid/alkali treatment.

Meanwhile, it is also under consideration to regenerate and recycle electrodes removed from waste batteries. Specifically, it is known to separate the electrodes in a used generating element (electrode unit) removed from a waste battery into a positive electrode and a negative electrode, clean them with polar solvent to remove degraded material, and recycle them (see Japanese Unexamined Patent Application, Publication No. 2012-22969, for example).

Patent Document 1: Japanese Unexamined Patent Application, Publication No. 2012-22969

### SUMMARY OF THE INVENTION

However, traditional methods require a burdensome work of separating used electrodes removed from a waste battery into the positive electrode and the negative electrode. Hence, for simplification of the process in recycling electrodes, the present inventors attempted cleaning an electrode unit removed from a waste battery with fluid while keeping it in the form of an electrode unit, without separating it into the positive electrode and the negative electrode. However, this method did not provide sufficient penetration of fluid into the electrode unit and its cleaning effect was low.

An object of the present invention is to provide a method of processing a battery that can efficiently make fluid penetrate into an electrode unit even in the form of an electrode unit, and a method of producing a battery that can produce a new battery from electrodes processed by the method of processing.

To attain the object, the present invention has the following aspects.
(1) A method of processing a battery (e.g., a lithium-ion battery 1 discussed later) is provided. The method performs processing by feeding fluid into an inside of the battery. The method includes a first step of providing a battery including one or more fluid inlets (e.g., fluid inlets 10a discussed later) and one or more fluid outlets (e.g., fluid outlets 10b discussed later) in an outer casing (e.g., an outer casing 10 discussed later), and a second step of cleaning the inside of the battery by injecting fluid through the fluid inlets and discharging the fluid from the fluid outlets.
(2) In the method of processing a battery as described in (1) above, the fluid includes supercritical fluid carbon dioxide.
(3) In the method of processing a battery as described in (1) above, the battery is a lithium-ion battery, and the method includes a step of before or after the second step, injecting, into the battery, lithium replenishing agent for replenishing an electrode in the battery with lithium ions.
(4) In the method of processing a battery as described in any of (1) to (3) above, the outer casing is cylindrical, and the fluid inlets and the fluid outlets are formed at axially opposite edges of the outer casing apart from each other.
(5) A method of producing a battery that produces a new battery (e.g., a lithium-ion battery 1A discussed later) by using the electrode processed by the method of processing a battery as described in any of (1) to (3) above is provided.

According to an embodiment of the present invention, it is possible to provide a method of processing a battery that can efficiently make fluid penetrate into an electrode even with the electrode housed in the outer casing, and a method of producing a battery that produces a new battery from the electrode processed by the method of processing.

### BRIEF DESCRIPTION OF THE DRAWINGS

FIG. 1 is a perspective view showing a lithium-ion battery according to an embodiment as exploded;

FIG. 2 is a cross-sectional view schematically showing a layered structure in the lithium-ion battery according to an embodiment;

FIG. 3 is a flow chart illustrating a method of processing a lithium-ion battery according to an embodiment;

FIG. 4 illustrates the method of processing a lithium-ion battery according to the embodiment;

FIG. 5 illustrates the method of processing a lithium-ion battery according to the embodiment;

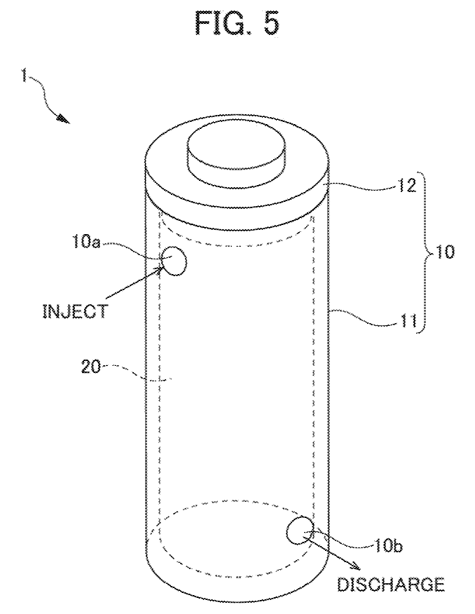

FIG. 6 illustrates supercritical fluid carbon dioxide;

FIG. 7 is a flowchart of a method of producing a lithium ion-battery according to an embodiment; and

FIG. 8 illustrates the method of producing a lithium-ion battery according to the embodiment.

### DETAILED DESCRIPTION OF THE INVENTION

An embodiment of the present invention will be described below in detail by taking a lithium-ion battery as an example. However, the description that follows is an example of an aspect of the present invention and the present invention is not limited to specifics in the example and can be practiced with modification within the scope of its spirit.

### Lithium-ion Battery

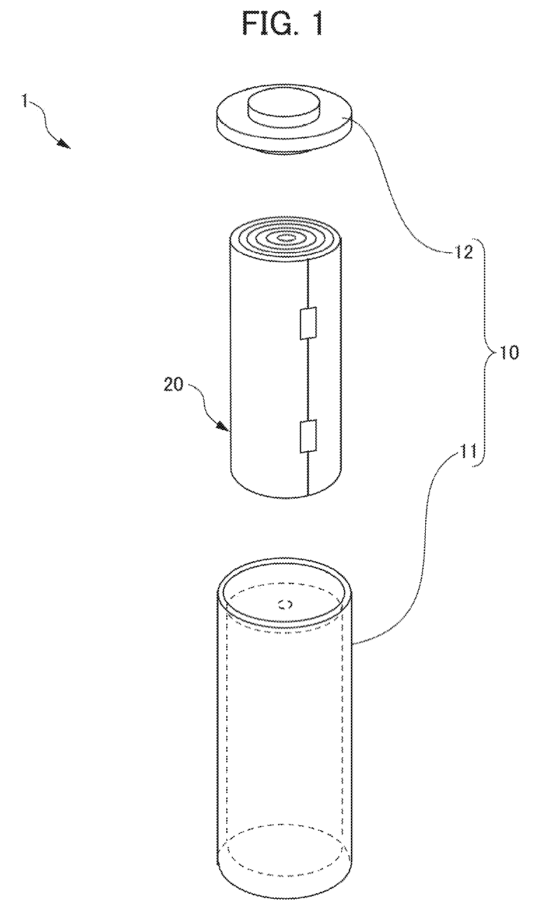

A lithium-ion battery to which the present invention is applicable is a secondary battery that uses lithium ions as charge carriers and achieves charging and discharging by way of movement of lithium ions between a positive electrode and a negative electrode serving as electrodes. As shown in FIG. 1, a lithium-ion battery 1 includes an outer casing 10 and a roll 20.

The outer casing 10 includes a cylindrical can 11 made of metal, and a lid 12 for covering the can 11. The roll 20 is structured by rolling a layered structure, which is a layer of a positive electrode 21, a negative electrode 22 and a separator 23 to be discussed later, into the shape of a cylinder. That is, the electrode unit is formed of the roll 20. The lithium-ion battery 1 is structured by placing the roll 20 in the can 11 together with electrolytic solution and covering the can 11 with the lid 12. The lithium-ion battery 1 thereby constitutes a battery cell.

### Electrolytic Solution

The electrolytic solution contains electrolyte and organic solvent. For the electrolyte, an electrolyte known in the art can be chosen. For example, it can be lithium salt such as LiClO₄, LiPF₆, LiAsF₆, LiSbFe₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, and Li₂B₁₀Cl₁₀. Any one of these electrolytes may be used alone, or two or more of them may be used in combination.

For the organic solvent, an organic solvent known in the art can be chosen and used. For example, it can be carbonate such as propylene carbonate, ethylene carbonate, diethyl carbonate, ethyl methyl carbonate, 4-trifluoromethyl-1,3-dioxolane-2-one, 1,2-di(methoxycarbonyloxy)ethane; ester such as methyl formate, methyl acetate, γ-butyrolactone; ether such as 1,2-dimethoxyethane, 1,3-dimethoxypropane, pentafluoropropyl methyl ether, 2,2,3,3-tetrafluoropropyldialoromethyl ether, tetrahydrofuran, 2-methyltetrahydrofuran; amide such as N,N-dimethylformamide and N,N-dimethylacetamide; nitrile such as acetonitrile and butyronitrile; carbamate such as 3-methyl-2-oxazolidone; and a sulfur-containing compound such as sulfolane, dimethyl sulfoxide, and 1,3-propane sultone. Any one of these organic solvents may be used alone, or two or more of them may be used in combination.

### Roll

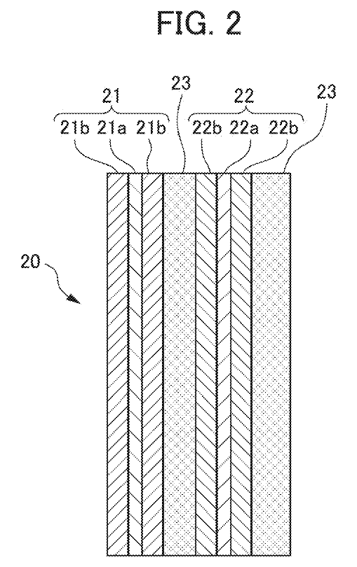

A layered structure that forms the roll 20 in the lithium-ion battery 1 is schematically shown in FIG. 2. The layered structure includes the positive electrode 21, the negative electrode 22, and the separator 23. The layered structure may also be a layer of two or more positive electrodes 21 and two or more negative electrodes 22 with the separator 23 positioned between each pair of them. In FIG. 2, they are layered in the order of the positive electrode 21, the separator 23, the negative electrode 22, and the separator 23 from the left. The roll 20 is formed by rolling this layered structure around an axis of rolling at high density.

### Positive Electrode

The positive electrode 21 includes a positive electrode current collector 21a and a positive electrode active material layer 21b provided on a surface of the positive electrode current collector 21a.

The positive electrode current collector 21a is an electrode foil made of metal foil such as aluminum foil and stainless foil. A carbon coating layer may be formed on the positive electrode current collector 21a. The positive electrode current collector 21a can be in the form of foil, plate, mesh etc., for example.

The positive electrode active material layer 21b can include positive electrode active material, conductivity additive, and binder. While the illustrated positive electrode 21 in this embodiment has the positive electrode active material layer 21b, 21b layered on both of surfaces of the positive electrode current collector 21a, the positive electrode active material layer 21b may also only be layered on either one surface of the positive electrode current collector 21a.

Any positive electrode active material that can occlude and release lithium ions can be used without limitation. Specific examples of positive electrode active material include lithium nickel oxide (e.g., LiNiO₂), lithium cobalt oxide (e.g., LiCoCO₂), lithium nickel cobalt oxide, lithium nickel cobalt manganese oxide, LiFePO₄, LiMn₁₋ₓFeₓPO₄, LiMnPO₄, LiCoPO₄, and LiNiPO₄.

The conductivity additive aids in formation of a conductive path between the positive electrode active material and the positive electrode current collector 21a. Specific examples of conductivity additive include carbon black such as acetylene black, carbon nanotube, and graphite such as artificial graphite, for example.

The binder binds each of the positive electrode active material, the conductivity additive and the positive electrode current collector 21a. Examples of binder include polyvinylidene fluoride (PVDF), polytetrafluoroethylene (PTFE), polyamide (PA), polyimide (PI), polyacrylic acid and a copolymer thereof, polyamide-imide (PAI), polybenzimidazole, polyether sulfone (PES), maleic anhydride-modified polypropylene and a mixture thereof, for example.

### Negative Electrode

The negative electrode 22 includes a negative electrode current collector 22a and a negative electrode active material layer 22b provided on a surface of the negative electrode current collector 22a.

The negative electrode current collector 22a is an electrode foil made of metal foil such as copper foil, stainless foil and nickel foil. A carbon coating layer may be formed on the negative electrode current collector 22a. The negative electrode current collector 22a can be in the form of foil, plate, mesh etc., for example.

The negative electrode active material layer 22b can include negative electrode active material, conductivity additive and binder. While the illustrated negative electrode 22 in this embodiment has the negative electrode active material layer 22b, 22b layered on both of surfaces of the negative electrode current collector 22a, the negative electrode active material layer 22b may also only be layered on either one surface of the negative electrode current collector 22a.

Any negative electrode active material that can occlude and release lithium ions can be used without limitation. Specific examples of negative electrode active material include graphite (artificial graphite and natural graphite), amorphous carbon (hard carbon), mesocarbon microbead, carbon fiber, Si material (silicon, Si metal, Si oxide), etc.

The conductivity additive aids in formation of a conductive path between the negative electrode active material and the negative electrode current collector 22a. Specific examples of conductivity additive include carbon black such as acetylene black, and carbon nanotube, for example.

The binder binds each of the negative electrode active material, the conductivity additive and the negative electrode current collector 22a. Examples of binder include carboxymethyl cellulose, polyvinylidene fluoride, polytetrafluoroethylene, polyacrylic acid, fluororubber, and diene rubber such as styrene-butadiene rubber, for example.

### Separator

The separator 23 can be porous sheet or non-woven fabric sheet, for example, without limitation. Examples of material for porous sheet include polyolefin such as polyethylene and polypropylene, aramid, polyimide, and fluororesin. Examples of material for non-woven fabric sheet include glass fiber and cellulose fiber.

### Electrode Recovery Process

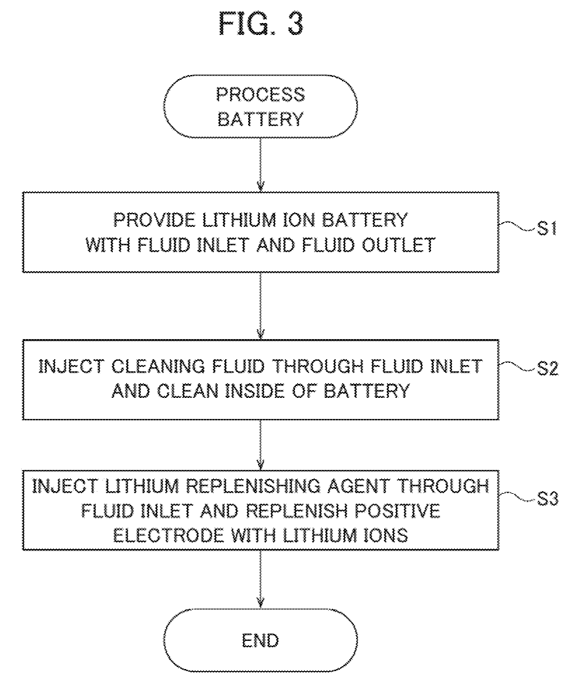

As the electrodes in a used lithium-ion battery 1 have been degraded, an electrode recovery process is performed on them. Degraded positive electrode 21 and negative electrode 22 have coating formed on their surfaces and furthermore lithium ions have been lost from inside of the positive electrode 21. Accordingly, removal of coating is performed on the positive electrode 21 and the negative electrode 22, while replenishment of lithium ions is performed on the positive electrode 21. FIG. 3 is a flowchart illustrating an example of the method of processing a lithium-ion battery including such a series of steps. Based on the flowchart, the method of processing a lithium-ion battery according to this embodiment is described.

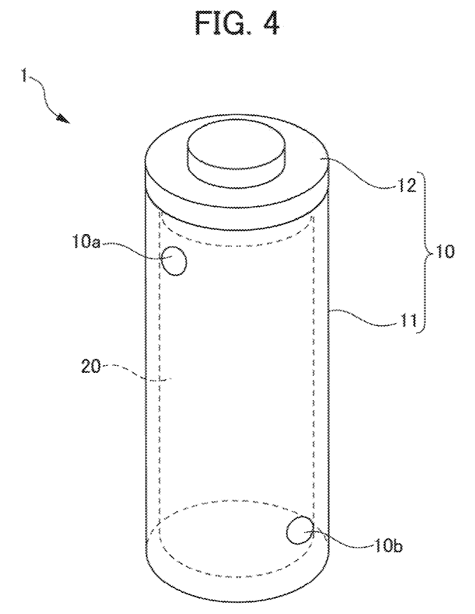

First, as shown in FIG. 4, a used lithium--ion battery 1 with a fluid inlet 10a and a fluid outlet 10b in the outer casing 10 is provided as a lithium--ion battery (step S1).

In the example shown in FIG. 4, the fluid inlet 10a and the fluid outlet 10b are each formed in a peripheral surface of the cylindrical can 11. In order to make fluid injected into the outer casing 10 efficiently penetrate into the positive electrode 21 in the roll 20, the fluid inlet 10a and the fluid outlet 10b are preferably formed at axially opposite edges of the can 11 apart from each other. This can secure a long flow path between the fluid inlet 10a and the fluid outlet 10b, allowing fluid to penetrate throughout the electrodes that forms the roll 20 (the positive electrode 21 and the negative electrode 22). The number of fluid inlets 10a and fluid outlet 10b formed is not limited to one, respectively. More than one fluid inlet 10a and more than one fluid outlet 10b may be formed in the outer casing 10.

Next, fluid is injected into the outer casing 10 through the fluid inlet 10a with the lid 12 covering the outer casing 10, and the fluid is discharged from the fluid outlet 10b (step S2). Specifically, cleaning fluid is injected through the fluid inlet 10a. The cleaning fluid is fluid for removing the coating formed on the surfaces of the electrodes (the positive electrode 21 and the negative electrode 22) and electrolytic solution.

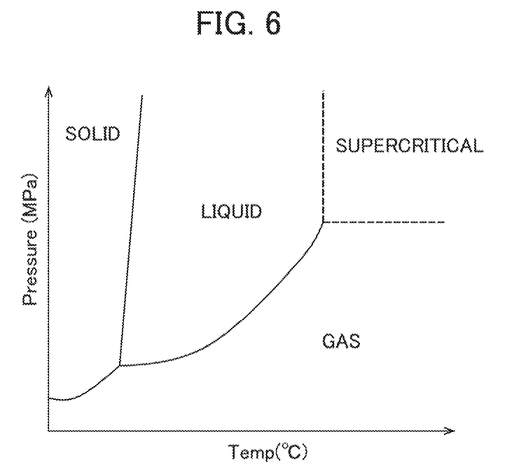

The cleaning fluid here is made of supercritical fluid carbon dioxide. Supercritical fluid carbon dioxide is produced by heating and pressurizing carbon dioxide to a critical temperature of 31°C or higher and a critical pressure of 7.4 MPa or higher, respectively, bringing it into a supercritical state where there is no longer boundary between liquid and gas, as shown in FIG. 6. Supercritical fluid carbon dioxide has properties that combine substance solubility like liquid and diffusibility like gas. Since supercritical fluid carbon dioxide can easily penetrate into narrow gaps in the roll 20, which is rolled at high density in the outer casing 10, it also can penetrate into the positive electrode 21 in the roll 20 efficiently. The cleaning fluid can include organic solvent such as acetone, diethyl carbonate (DEC), isopropyl alcohol (IPA) and propylene carbonate (PC), as well as supercritical fluid carbon dioxide. With such an organic solvent, it is possible to adjust polarity of the cleaning fluid and in turn the cleaning effect.

Injection of cleaning fluid into the outer casing 10 through the fluid inlet 10a causes the electrolytic solution stored in the outer casing 10 with the roll 20 and reaction degraded material (coating) to be discharged from the fluid outlet 10b with cleaning fluid. Through these steps, the positive electrode 21, the negative electrode 22, and furthermore the roll 20 can be cleaned efficiently.

After step S2, there may be a step of injecting lithium replenishing agent into the outer casing 10. That is, lithium replenishing agent is injected through the fluid inlet 10a with supercritical fluid carbon dioxide, and coating remover inside is discharged from the fluid outlet 10b (step S3). The lithium replenishing agent is lithium dopant that contains lithium ions for replenishing the positive electrode 21, from which lithium ions have been lost, with lithium ions anew. Specific examples of lithium replenishing agent include solution that contains an anion radical of aromatic hydrocarbon such as naphthalin, pyrene, perylene and biphenyl, and lithium ions, or solution that contains trifluoromethanesulfinic acid lithium, for example.

In order to make the lithium replenishing agent injected into the outer casing 10 with supercritical fluid carbon dioxide penetrate sufficiently into the positive electrode 21 and to dope the positive electrode 21 with lithium ions, it is preferable to leave the battery to stand for a predefined amount of time after the injection of lithium replenishing agent, with the fluid inlet 10a and the fluid outlet 10b closed. A way of closing the fluid inlet 10a and the fluid outlet 10b can be to stick resin tape made of polyimide resin and the like over the fluid inlet 10a and the fluid outlet 10b, for example.

After injecting lithium replenishing agent and leaving the battery to stand for a predefined amount of time, supercritical fluid carbon dioxide and organic solvent are injected through the fluid inlet 10a and lithium replenishing agent inside is discharged from the fluid outlet 10b. For the organic solvent, the solvents mentioned for step S2 can be used. The recovery process for the electrodes (the roll) thus ends.

### Producing a Battery

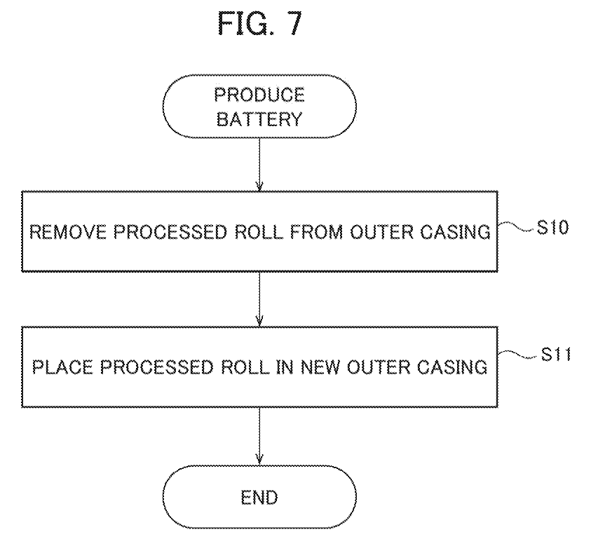

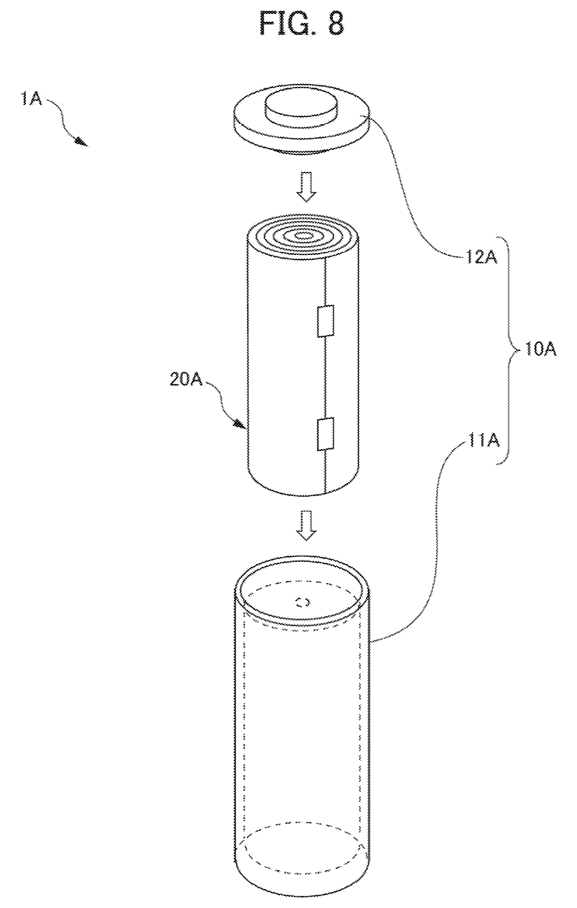

Next, a method of producing a new lithium-ion battery using a roll after the recovery process on the electrodes therein is described with reference to FIGS. 7 and 8.

The roll 20A after the recovery process on the electrodes is first removed from the outer casing 10 (step S10). Subsequently, as shown in FIG. 8, a new outer casing 10A including a can 11A and a lid 12A is prepared and the processed roll 20A is placed into the can 11A. After that, electrolytic solution is injected into the can 11A and the can 11A is covered with the lid 12A. A new lithium-ion battery 1A is thereby made.

In the method of producing a battery described above, the roll 20A after the recovery process is removed from the outer casing 10. However, instead of removing the roll 20A from the outer casing 10, the roll 20A can also be recycled with the outer casing 10, such as by sealing the fluid inlet and the fluid outlet with plugs. According to the method, a new battery can be produced with an electrode that has been efficiently processed.

### EXAMPLES

### Example

As a battery to be processed, a used, 21700-type lithium-ion battery was prepared (cylindrical, with a 21-mm diameter and a 70-mm length). Four holes were formed as fluid outlets on a side surface of the outer casing of the lithium-ion battery near a bottom. Likewise, four holes were formed as fluid inlets in the side surface near a lid part. Next, fluid which is a mixture of supercritical fluid carbon dioxide at a temperature of 60° C and acetone (40mL of acetone and 800 g of carbon dioxide) was injected from each fluid inlet and discharged from the fluid outlets (a pressure of 30 MPa and a flow rate of 20g/min). After performing this operation, determining a change in weight of the battery before and after the injection showed a reduction of 4.55g after the injection process compared to before the injection process. This is due to discharge of the electrolytic solution and reaction degraded material inside as a result of fluid injection.

### Comparative Example

As with Example, a used, 21700-type lithium-ion battery was prepared. The roll was removed from this battery. The roll was placed in a cleaning vessel filled with glass beads (about 2mm in diameter) for fixation, and fluid which is a mixture of supercritical fluid carbon dioxide at a temperature of 60° C and acetone was fed into the cleaning vessel (a pressure of 30 Mpa and a flow rate of 20g/min) as with Example. A change in the weight of the battery before and after the processing (a difference between the weight of the prepared battery and the weight of the processed roll and the outer casing) was determined to be 0.85g. Although electrolytic solution and the like were removed by the fluid, the removal was small in volume compared to Example.

From the results of Example and the comparative example above, by feeding fluid with the roll placed in the outer casing as was done in Example, a large amount of electrolytic solution and reaction degraded material was removed. This is presumably because feeding of fluid between the fluid inlets and the fluid outlets formed in the outer casing enabled efficient penetration of fluid into the electrodes. In addition, electrodes can be cleaned in a simple way of boring holes in the outer casing without breaking down the battery.

In the detailed description of the invention above, the step of injecting the lithium replenishing agent is executed after step S2. But the step of injecting the lithium replenishing agent may be executed before step S2.

### EXPLANATION OF REFERENCE NUMERALS

1,1A lithium ion battery

10,10A outer casing

10a fluid inlet

10b fluid outlet

20 roll

21 positive electrode

22 negative electrode

What is claimed is:

1. A method of processing a battery, the method performing processing by feeding fluid into an inside of the battery, the method comprising:
providing a battery including one or more fluid inlets and one or more fluid outlets in an outer casing; and
cleaning the inside of the battery by injecting fluid through the fluid inlets and discharging the fluid from the fluid outlets.

2. The method of processing a battery according to claim 1, wherein the fluid comprises supercritical fluid carbon dioxide.

3. The method of processing a battery according to claim 1, wherein the battery is a lithium-ion battery, and the method comprises, before or after the cleaning of the inside of the battery, injecting, into the battery, lithium replenishing agent for replenishing an electrode in the battery with lithium ions.

4. The method of processing a battery according to claim 1, wherein
the outer casing is cylindrical, and
the fluid inlets and the fluid outlets are formed at axially opposite edges of the outer casing apart from each other.

5. A method of producing a battery that produces a new battery by using the electrode processed by the method of processing a battery according to claim 1.
